(19) United States
(12) Patent Application Publication
(10) Pub. No.: US 2015/0163587 A1
(43) Pub. Date: Jun. 11, 2015

(54) Audio Information Processing Method and Apparatus

(71) Applicant: Huawei Technologies Co., Ltd., Shenzhen (CN)

(72) Inventor: Haiting Li, Beijing (CN)

(21) Appl. No.: 14/542,820

(22) Filed: Nov. 17, 2014

(30) Foreign Application Priority Data
Dec. 6, 2013 (CN) 201310656703.5

(51) Int. Cl. H04R 1/32; H04R 3/00; H04N 7/18

(52) U.S. Cl. CPC H04R 1/326; H04N 7/18; H04R 3/00; H04N 2201/0084; H04N 2201/0096; H04N 2201/3264

(57) ABSTRACT

An audio information processing method and apparatus are provided. The method includes determining a first camera, acquiring first audio information collected by the first audio collecting unit, acquiring second audio information collected by the second audio collecting unit, processing the first audio information and the second audio information to obtain third audio information, where for the third audio information, a gain of a sound signal coming from a shooting direction of the first camera is a first gain and a gain of a sound signal coming from an opposite direction of the shooting direction is a second gain, and outputting the third audio information. When the method or the apparatus of the present application is adopted, in synchronously output audio information, volume of a target sound source in a final video image is higher than volume of noise or an interfering sound source outside the video image.

### CROSS-REFERENCE TO RELATED APPLICATIONS

This application claims priority to Chinese Patent Application No. 201310656703.5, filed with the Chinese Patent Office on Dec. 6, 2013, which is incorporated herein by reference in its entirety.

### TECHNICAL FIELD

The present application relates to the information processing field, and in particular, to an audio information processing method and apparatus.

### BACKGROUND

With the continuous advancement of science and technology, an electronic product has an increasing number of functions. At present, an overwhelming majority of portable electronic devices have an audio information collecting function and can output collected audio information. A mobile phone is an example. When a mobile phone is used to perform operations such as making a call and recording a video, an audio information collecting function of the mobile phone is applied.

However, in the prior art, when an electronic device is used to collect audio information, basically, the audio information collected by the electronic device is directly output or saved without being further processed, which causes that in the audio information collected by the electronic device, volume of noise or an interfering sound source may be higher than volume of a target sound source.

For example, when a mobile phone is used to record a video, because a user who performs shooting is close to the mobile phone, a sound, made by the user, in a recorded video is usually louder than a sound made by a shot object, which causes that in the audio information collected by the electronic device, the volume of the target sound source is lower than the volume of the noise or the interfering sound source.

### SUMMARY

An objective of the present application is to provide an audio information processing method and apparatus, which can solve, by processing audio information collected by an audio collecting unit, a problem that volume of a sound source is lower than volume of noise.

To achieve the foregoing objective, the present application provides the following solutions.

According to a first possible implementation manner of a first aspect of the present application, the present application provides an audio information processing method applied to an electronic device, the electronic device has at least a front-facing camera and a rear-facing camera, a camera in a started state from the front-facing camera and the rear-facing camera is a first camera, at least one audio collecting unit on a side on which the front-facing camera is located, and at least one audio collecting unit on a side on which the rear-facing camera is located, where when the front-facing camera is the first camera, the audio collecting unit on the side on which the front-facing camera is located is configured as a first audio collecting unit and the audio collecting unit on the side on which the rear-facing camera is located is configured as a second audio collecting unit, where when the rear-facing camera is the first camera, the audio collecting unit on the side on which the rear-facing camera is located is configured as a first audio collecting unit and the audio collecting unit on the side on which the front-facing camera is located is configured as a second audio collecting unit, and where the method includes determining the first camera, acquiring first audio information collected by the first audio collecting unit, acquiring second audio information collected by the second audio collecting unit, processing the first audio information and the second audio information to obtain third audio information, where a gain of a sound signal from a shooting direction of the first camera is a first gain for the third audio information, a gain of a sound signal from an opposite direction of the shooting direction is a second gain for the third audio information, and the first gain is greater than the second gain, and outputting the third audio information.

With reference to a second possible implementation manner of the first aspect, both the first audio collecting unit and the second audio collecting unit are omnidirectional audio collecting units, and where the processing the first audio information and the second audio information to obtain third audio information includes processing, by using a differential array processing technique, the first audio information and the second audio information to obtain the third audio information, where after the processing by using the differential array processing technique is performed, a beam of an overall collecting unit including the first audio collecting unit and the second audio collecting unit is a cardioid, and where a direction of a maximum value of the cardioid is the same as the shooting direction, and a direction of a minimum value is the same as the opposite direction of the shooting direction.

With reference to a third possible implementation manner of the first aspect, both the first audio collecting unit and the second audio collecting unit are omnidirectional audio collecting units, and the processing the first audio information and the second audio information to obtain third audio information includes processing, in a first processing mode, the first audio information and the second audio information to obtain fourth audio information; processing, in a second processing mode, the first audio information and the second audio information to obtain fifth audio information, where in the first processing mode, a beam of an overall collecting unit including the first audio collecting unit and the second audio collecting unit is a first beam, and where, in the second processing mode, a beam of an overall collecting unit including the first audio collecting unit and the second audio collecting unit is a second beam, where the first beam and the second beam have different directions; and synthesizing, according to a preset weighting coefficient, the fourth audio information and the fifth audio information to obtain the third audio information.

With reference to a fourth possible implementation manner of the first aspect, the first audio collecting unit is an omnidirectional audio collecting unit, where the second audio collecting unit is a cardioid audio collecting unit, where a direction of a maximum value of the cardioid is the same as the opposite direction of the shooting direction, where a direction of a minimum value is the same as the shooting direction, and wherein the processing the first audio information and the second audio information to obtain third audio information includes using the first audio information as a target signal and the second audio information as a reference noise signal, and performing noise suppression processing on the first audio information and the second audio information to obtain the third audio information.

With reference to a fifth possible implementation manner of the first aspect, the first audio collecting unit is a first cardioid audio collecting unit, where the second audio collecting unit is a second cardioid audio collecting unit, where a direction of a maximum value of the first cardioid is the same as the shooting direction, where a direction of a minimum value is the same as the opposite direction of the shooting direction, where a direction of a maximum value of the second cardioid is the same as the opposite direction of the shooting direction, where a direction of a minimum value is the same as the shooting direction, and where the processing the first audio information and the second audio information to obtain third audio information specifically includes using the first audio information as a target signal and the second audio information as a reference noise signal, and performing noise suppression processing on the first audio information and the second audio information to obtain the third audio information.

According to a first possible implementation manner of a second aspect of the present application, the present application provides another audio information processing method applied to an electronic device having at least a front-facing camera and a rear-facing camera, where a camera in a started state from the front-facing camera and the rear-facing camera is a first camera, at least one audio collecting unit on a side on which the front-facing camera is located, and at least one audio collecting unit on a side on which the rear-facing camera is located, where when the front-facing camera is the first camera, the audio collecting unit on the side on which the front-facing camera is located is configured as a first audio collecting unit and the audio collecting unit on the side on which the rear-facing camera is located is configured as a second audio collecting unit, where when the rear-facing camera is the first camera, the audio collecting unit on the side on which the rear-facing camera is located is configured as a first audio collecting unit and the audio collecting unit on the side on which the front-facing camera is located is configured as a second audio collecting unit, and the method includes determining the first camera, enabling the first audio collecting unit, disabling the second audio collecting unit, acquiring first audio information collected by the first audio collecting unit, and outputting the first audio information.

According to a first possible implementation manner of a third aspect of the present application, the present application provides an audio information processing apparatus applied to an electronic device having at least a front-facing camera and a rear-facing camera, where a camera in a started state from the front-facing camera and the rear-facing camera is a first camera, at least one audio collecting unit on a side on which the front-facing camera is located, and at least one audio collecting unit on a side on which the rear-facing camera is located, where when the front-facing camera is the first camera, the audio collecting unit on the side on which the front-facing camera is located is configured as a first audio collecting unit and the audio collecting unit on the side on which the rear-facing camera is located is configured as a second audio collecting unit, where when the rear-facing camera is the first camera, the audio collecting unit on the side on which the rear-facing camera is located is configured as a first audio collecting unit and the audio collecting unit on the side on which the front-facing camera is located is configured as a second audio collecting unit, and the apparatus includes a determining unit configured to determine the first camera, an acquiring unit configured to acquire first audio information collected by the first audio collecting unit and to acquire second audio information collected by the second audio collecting unit, a processing unit configured to process the first audio information and the second audio information to obtain third audio information, where a gain of a sound signal coming from a shooting direction of the first camera is a first gain for the third audio information, a gain of a sound signal coming from an opposite direction of the shooting direction is a second gain for the third audio information, and the first gain is greater than the second gain, and an output unit configured to output the third audio information.

With reference to a second possible implementation manner of the third aspect, both the first audio collecting unit and the second audio collecting unit are omnidirectional audio collecting units, and where the processing unit is configured to process, by using a differential array processing technique, the first audio information and the second audio information to obtain the third audio information, where after the processing by using the differential array processing technique is performed, a beam of an overall collecting unit including the first audio collecting unit and the second audio collecting unit is a cardioid, and where a direction of a maximum value of the cardioid is the same as the shooting direction, and a direction of a minimum value is the same as the opposite direction of the shooting direction.

With reference to a third possible implementation manner of the third aspect, both the first audio collecting unit and the second audio collecting unit are omnidirectional audio collecting units, and where the processing unit is configured to process, in a first processing mode, the first audio information and the second audio information to obtain fourth audio information, process, in a second processing mode, the first audio information and the second audio information to obtain fifth audio information, where in the first processing mode, a beam of an overall collecting unit including the first audio collecting unit and the second audio collecting unit is a first beam, and where in the second processing mode, a beam of an overall collecting unit including the first audio collecting unit and the second audio collecting unit is a second beam, where the first beam and the second beam have different directions, and synthesize, according to a preset weighting coefficient, the fourth audio information and the fifth audio information to obtain the third audio information.

With reference to a fourth possible implementation manner of the third aspect, the first audio collecting unit is an omnidirectional audio collecting unit, and where the second audio collecting unit is a cardioid audio collecting unit, where a direction of a maximum value of the cardioid is the same as the opposite direction of the shooting direction, where a direction of a minimum value is the same as the shooting direction, and where the processing unit is configured to use the first audio information as a target signal and the second audio information as a reference noise signal, and perform noise suppression processing on the first audio information and the second audio information to obtain the third audio information.

With reference to a fifth possible implementation manner of the third aspect, the first audio collecting unit is a first cardioid audio collecting unit, and where the second audio collecting unit is a second cardioid audio collecting unit, where a direction of a maximum value of the first cardioid is the same as the shooting direction, where a direction of a minimum value is the same as the opposite direction of the shooting direction, where a direction of a maximum value of the second cardioid is the same as the opposite direction of the shooting direction, where a direction of a minimum value is the same as the shooting direction; and where the processing unit is configured to use the first audio information as a target signal and the second audio information as a reference noise signal, and perform noise suppression processing on the first audio information and the second audio information to obtain the third audio information.

According to a first possible implementation manner of a fourth aspect of the present application, the present application provides another audio information processing apparatus applied to an electronic devicehaving at least a front-facing camera and a rear-facing camera, where a camera in a started state from the front-facing camera and the rear-facing camera is a first camera, at least one audio collecting unit on a side on which the front-facing camera is located, and at least one audio collecting unit on a side on which the rear-facing camera is located, where when the front-facing camera is the first camera, the audio collecting unit on the side on which the front-facing camera is located is configured as a first audio collecting unit and the audio collecting unit on the side on which the rear-facing camera is located is configured as a second audio collecting unit, where when the rear-facing camera is the first camera, the audio collecting unit on the side on which the rear-facing camera is located is configured as a first audio collecting unit and the audio collecting unit on the side on which the front-facing camera is located is configured as a second audio collecting unit, where a beam of the first audio collecting unit is a cardioid, where a direction of a maximum value of the cardioid is the same as the shooting direction, where a direction of a minimum value is the same as an opposite direction of the shooting direction, and where the apparatus includes a determining unit configured to determine the first camera, an enabling unit configured to enable the first audio collecting unit, a disabling unit configured to disable the second audio collecting unit, an acquiring unit configured to acquire first audio information collected by the first audio collecting unit, and an output unit configured to output the first audio information.

According to a first possible implementation manner of a fifth aspect of the present application, the present application provides an electronic device having at least a front-facing camera and a rear-facing camera, where a camera in a started state from the front-facing camera and the rear-facing camera is a first camera, at least one audio collecting unit on a side on which the front-facing camera is located, and at least one audio collecting unit on a side on which the rear-facing camera is located, where when the front-facing camera is the first camera, the audio collecting unit on the side on which the front-facing camera is located is configured as a first audio collecting unit and the audio collecting unit on the side on which the rear-facing camera is located is configured as a second audio collecting unit, where when the rear-facing camera is the first camera, the audio collecting unit on the side on which the rear-facing camera is located is configured as a first audio collecting unit and the audio collecting unit on the side on which the front-facing camera is located is configured as a second audio collecting unit, and where the electronic device further includes any audio information processing apparatus according to the third aspect and the fourth aspect.

According to a first possible implementation manner of a sixth aspect of the present application, the present application provides another electronic device having at least a front-facing camera and a rear-facing camera, where a camera in a started state from the front-facing camera and the rear-facing camera is a first camera, at least one audio collecting unit on a side on which the front-facing camera is located, and at least one audio collecting unit on a side on which the rear-facing camera is located, where when the front-facing camera is the first camera, the audio collecting unit on the side on which the front-facing camera is located is configured as a first audio collecting unit and the audio collecting unit on the side on which the rear-facing camera is located is configured as a second audio collecting unit, where when the rear-facing camera is the first camera, the audio collecting unit on the side on which the rear-facing camera is located is configured as a first audio collecting unit and the audio collecting unit on the side on which the front-facing camera is located is configured as a second audio collecting unit, where a beam of the first audio collecting unit is a cardioid, where a direction of a maximum value of the cardioid is the same as the shooting direction, where a direction of a minimum value is the same as an opposite direction of the shooting direction, and where the electronic device further includes the audio information processing apparatus according to the fourth aspect.

According to specific embodiments provided in the present application, the present application discloses the following technical effects.

According to an audio information processing method or apparatus disclosed in the present application, a first camera is determined, audio information collected by the first audio collecting unit and the second audio collecting unit is processed to obtain third audio information, where for the third audio information, a gain of a sound signal coming from a shooting direction of the camera is a first gain with a larger gain value and a gain of a sound signal coming from an opposite direction of the shooting direction is a second gain with a smaller gain value, so that when an electronic device is used for video shooting and audio collecting at the same time, volume of a target sound source in a video shooting direction can be increased and volume of noise or an interfering sound source in an opposite direction of the video shooting direction can be decreased. Therefore, in synchronously output audio information, volume of a target sound source in a final video image is higher than volume of noise or an interfering sound source outside the video image.

### BRIEF DESCRIPTION OF DRAWINGS

To describe the technical solutions in the embodiments of the present application or in the prior art more clearly, the following briefly introduces the accompanying drawings required for describing the embodiments. The accompanying drawings in the following description show merely some embodiments of the present application, and a person of ordinary skill in the art may still derive other drawings from these accompanying drawings without creative efforts.

FIG. 1 is a flowchart of Embodiment 1 of an audio information processing method according to the present application.

FIG. 2 is a schematic diagram of beam directionality of a first audio collecting unit and a second audio collecting unit in Embodiment 2 and Embodiment 3 of an audio information processing method according to the present application.

FIG. 3 is a flowchart of Embodiment 2 of an audio information processing method according to the present application.

FIG. 4 is a schematic diagram of beam directionality of an overall collecting unit including a first audio collecting unit and a second audio collecting unit after a differential array processing technique is used in Embodiment 2 of an audio information processing method according to the present application.

FIG. 5 is a flowchart of Embodiment 3 of an audio information processing method according to the present application.

FIG. 6 is a schematic diagram of beam directionality of a first beam of an overall collecting unit including a first audio collecting unit and a second audio collecting unit after a first processing mode is used in Embodiment 3 of an audio information processing method according to the present application.

FIG. 7 is a schematic diagram of beam directionality of a second beam of an overall collecting unit including a first audio collecting unit and a second audio collecting unit after a second processing mode is used in Embodiment 3 of an audio information processing method according to the present application.

FIG. 8 is a schematic diagram of first beam directionality of a first audio collecting unit in Embodiment 4 of an audio information processing method according to the present application.

FIG. 9 is a schematic diagram of second beam directionality of a first audio collecting unit in Embodiment 4 of an audio information processing method according to the present application.

FIG. 10 is a schematic diagram of beam directionality of a second audio collecting unit in Embodiment 4 of an audio information processing method according to the present application.

FIG. 11 is a flowchart of Embodiment 4 of an audio information processing method according to the present application.

FIG. 12 is a flowchart of Embodiment 1 of another audio information processing method according to the present application.

FIG. 13 is a flowchart of Embodiment 1 of an audio information processing apparatus according to the present application.

FIG. 14 is a structural diagram of Embodiment 1 of another audio information processing apparatus according to the present application.

FIG. 15 is a structural diagram of a computing node according to the present application.

FIG. 16 is a front schematic structural diagram of an electronic device according to an embodiment of the present application.

FIG. 17 is a rear schematic structural diagram of an electronic device according to an embodiment of the present application.

FIG. 18 is a front schematic structural diagram of an electronic device according to an embodiment of the present application.

FIG. 19 is a rear schematic structural diagram of an electronic device according to an embodiment of the present application.

### DESCRIPTION OF EMBODIMENTS

The following clearly describes the technical solutions in the embodiments of the present application with reference to the accompanying drawings in the embodiments of the present application. The described embodiments are merely a part rather than all of the embodiments of the present application. All other embodiments obtained by a person of ordinary skill in the art based on the embodiments of the present application without creative efforts shall fall within the protection scope of the present application.

To make the foregoing objectives, characteristics, and advantages of the present application clearer and more comprehensible, the following describes the present application in more detail with reference to the accompanying drawings and specific embodiments.

An audio information processing method of the present application is applied to an electronic device, where the electronic device has at least a front-facing camera and a rear-facing camera, a camera in a started state from the front-facing camera and the rear-facing camera is a first camera, and there is at least one first audio collecting unit on one side on which the first camera is located, and there is at least one second audio collecting unit on the other side.

The electronic device may be a mobile phone, a tablet computer, a digital camera, a digital video recorder, or the like. The first camera may be the front-facing camera, and may also be the rear-facing camera. The audio collecting unit may be a microphone. The electronic device of the present application has at least two audio collecting units. There is at least one audio collecting unit on the side on which the front-facing camera is located, and there is at least one audio collecting unit on the side on which the rear-facing camera is located. When the front-facing camera is the first camera, the audio collecting unit on the side on which the front-facing camera is located is configured as a first audio collecting unit and the audio collecting unit on the side on which the rear-facing camera is located is configured as a second audio collecting unit. When the rear-facing camera is the first camera, the audio collecting unit on the side on which the rear-facing camera is located is configured as a first audio collecting unit and the audio collecting unit on the side on which the front-facing camera is located is configured as a second audio collecting unit.

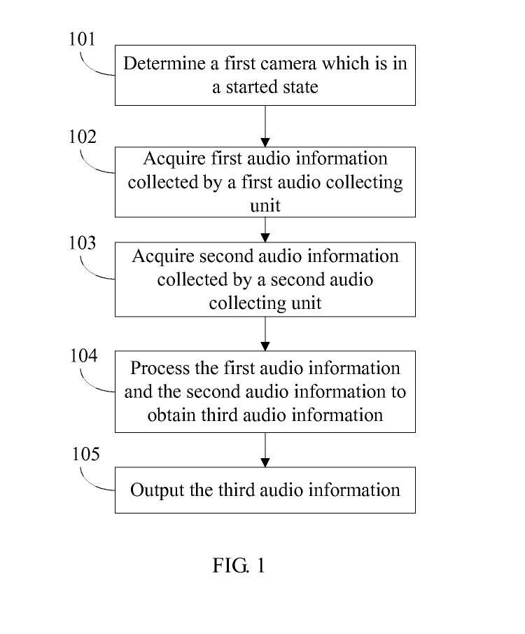

FIG. 1 is a flowchart of Embodiment 1 of an audio information processing method according to the present application. As shown in FIG. 1, the method may include the following steps.

Step 101: Determine the first camera.

Generally, the camera of the electronic device is not in the started state all the time. When it is required to use the camera to shoot an image, the camera of the electronic device may be started.

When the camera is started, it may be determined, according to a signal change of a circuit of the camera, whether the camera in the started state is the front-facing camera or the rear-facing camera. Certainly, the front-facing camera and the rear-facing camera may also be in the started state at the same time.

It should be noted that a button used to indicate a state of the camera may also be configured for the electronic device. After a user performs an operation on the button, it can be determined that the camera is in the started state. It should further be noted that on some special occasions, after performing an operation on the button, the user may only switch the state of the camera, and does not necessarily really start the camera at a physical level.

It should further be noted that when the electronic device has multiple cameras, it can be determined in this step that a camera in the started state is the first camera.

For example, the electronic device has a front-facing camera and a rear-facing camera. If the front-facing camera is in the started state, it can be determined in this step that the front-facing camera is the first camera, the first audio collecting unit is on a side on which the front-facing camera of the electronic device is located, and the second audio collecting unit is on a side on which the rear-facing camera of the electronic device is located. If the rear-facing camera is in the started state, it can be determined in this step that the rear-facing camera is the first camera, the first audio collecting unit is on the side on which the rear-facing camera of the electronic device is located, and the second audio collecting unit is on the side on which the front-facing camera of the electronic device is located.

If both the front-facing camera and the rear-facing camera are in the started state, for audio information collected in real time by all audio collecting units of the electronic device, the audio information processing method of this embodiment may be performed by using the front-facing camera as the first camera so as to obtain one piece of third audio information with the front-facing camera used as the first camera. Meanwhile, the audio information processing method of this embodiment is performed by using the rear-facing camera as the first camera so as to obtain one piece of third audio information with the rear-facing camera used as the first camera. These two pieces of third audio information are output at the same time. When the front-facing camera is used as the first camera, the first audio collecting unit is on the side on which the front-facing camera of the electronic device is located and the second audio collecting unit is on the side on which the rear-facing camera of the electronic device is located. When the rear-facing camera is used as the first camera, the first audio collecting unit is on the side on which the rear-facing camera of the electronic device is located and the second audio collecting unit is on the side on which the front-facing camera of the electronic device is located.

Step 102: Acquire first audio information collected by the first audio collecting unit.

When the first audio collecting unit is powered on and works properly, audio information collected by the first audio collecting unit is the first audio information.

Step 103: Acquire second audio information collected by the second audio collecting unit.

When the second audio collecting unit is powered on and works properly, audio information collected by the second audio collecting unit is the second audio information.

Step 104: Process the first audio information and the second audio information to obtain third audio information. For the third audio information, a gain of a sound signal coming from a shooting direction of the first camera is a first gain. For the third audio information, a gain of a sound signal coming from an opposite direction of the shooting direction is a second gain. The first gain is greater than the second gain.

By using a sound processing technique, different adjustments may be made to audio information from different directions so that adjusted audio information has different gains in different directions. After being processed, audio information collected from a direction in which there is a larger gain has higher volume. After being processed, audio information collected from a direction in which there is a smaller gain has lower volume.

When the camera is the front-facing camera, the shooting direction of the camera is a direction which the front of the electronic device faces. When the camera is the rear-facing camera, the shooting direction of the camera is a direction which the rear of the electronic device faces.

When the camera is used for shooting, audio information, such as a person's voice, that the electronic device needs to collect generally comes from a shooting range. Therefore, the gain of the sound signal coming from the shooting direction of the camera is adjusted to be the first gain with a larger gain value, which can increase volume of the audio information from the shooting range, making volume of a speaker's voice expected to be recorded higher. In addition, the gain of the sound signal coming from the opposite direction of the shooting direction is adjusted to be the second gain with a smaller gain value, which can suppress volume of audio information coming from a non-shooting range, making volume of noise or an interfering sound source in a background lower.

Step 105: Output the third audio information.

The outputting the third audio information may be that the third audio information is output to a video file for storing, where the video file is recorded by the electronic device, and may also be that the third audio information is directly output and transmitted to an electronic device which is communicating with the electronic device for direct real-time play.

In conclusion, according to the method of this embodiment, a first camera is determined and audio information collected by the first audio collecting unit and the second audio collecting unit is processed to obtain third audio information. For the third audio information, a gain of a sound signal coming from a shooting direction of the first camera is a first gain with a larger gain value and a gain of a sound signal coming from an opposite direction of the shooting direction is a second gain with a smaller gain value so that when an electronic device is used for video shooting and audio collecting at the same time, volume of a sound source in a video shooting direction can be increased and volume of noise or an interfering sound source in an opposite direction of the video shooting direction can be decreased. Therefore, in synchronously output audio information, volume of a target sound source in a final video image is higher than volume of noise or an interfering sound source outside the video image.

The following describes a method of the present application with reference to a physical attribute of an audio collecting unit and a position in which an audio collecting unit is disposed in an electronic device.

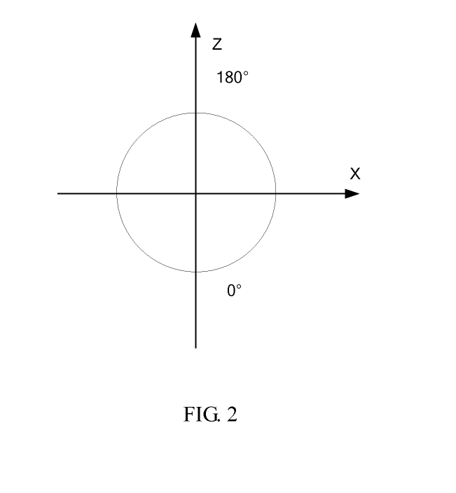

FIG. 2 is a schematic diagram of beam directionality of a first audio collecting unit and a second audio collecting unit in Embodiment 2 and Embodiment 3 of an audio information processing method according to the present application. In the schematic diagram of the beam directionality, a closed curve without coordinate axes is referred to as a beam. A distance between a point on the beam and an origin represents a gain value, picked up by an audio collecting unit, of a sound in a direction of a connecting line of the point and the origin.

In FIG. 2, both the first audio collecting unit and the second audio collecting unit are omnidirectional audio collecting units. The so-called “omnidirectional” refers to that picked-up gains of audio information from all directions are the same.

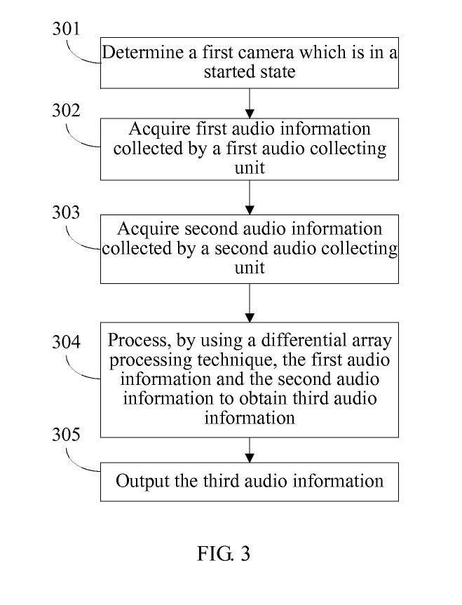

FIG. 3 is a flowchart of Embodiment 2 of an audio information processing method according to the present application. As shown in FIG. 3, the method may include the following steps.

Step 301: Determine the first camera which is in the started state.

Step 302: Acquire first audio information collected by the first audio collecting unit.

Step 303: Acquire second audio information collected by the second audio collecting unit.

Step 304: Process, by using a differential array processing technique, the first audio information and the second audio information to obtain a third audio information.

After the differential array processing technique is used, a beam of an overall collecting unit including the first audio collecting unit and the second audio collecting unit is a cardioid, and a direction of a maximum value of the cardioid is the same as a shooting direction, and a direction of a minimum value is the same as an opposite direction of the shooting direction.

In differential array processing, it is required to design a weighting coefficient of a differential beamformer according to responses at different configured angles and a position relationship between microphones and then store the designed weighting coefficient.

It is assumed that N is the number of microphones included in a microphone array, and in principle, degrees of responses at M angles may be configured, where M≦N, M is a positive integer; the i^{th} angle is θᵢ; and according to a periodicity of the cosine function, θᵢ may be any angle. If a response at the i^{th} angle is βᵢ, i=1,2, . . . , M, a formula to calculate the weighting coefficient by using a method for designing a differential beamforming weighting coefficient is as follows:

h(ω)=D⁻¹(ω,θ)β

A formula of a steering array D(ω,θ) is as follows:

$$D ( ω , θ ) = [ \begin{matrix}{d}^{H} ( ω , cos {θ}_{1} ) \\ {d}^{H} ( ω , cos {θ}_{2} ) \\ ⋮ \\ {d}^{H} ( ω , cos {θ}_{M} )\end{matrix} ] , \\ d ( ω , cos {θ}_{1} ) = {[ \begin{matrix}{e}^{- {jωτ}_{1} cos {θ}_{i}} & {e}^{- {jωτ}_{2} cos {θ}_{i}} & … & {e}^{- {jωτ}_{N} cos {θ}_{i}}\end{matrix} ]}^{T} , \\ i = 1 , 2 , … , M$$

A formula of a response matrix β is as follows:

β=[β₁ β₂ . . . B_{M}]^{T}.

A superscript −1 in the formula denotes an inverse operation, and a superscript T denotes a transpose operation.

$${τ}_{k} = \frac{{d}_{k}}{c} , where k = 1 , 2 , … , N ,$$

c is a sound velocity and generally may be 342 m/s or 340 m/s; dₖ is a distance between the k^{th} microphone and a configured origin position of the array. Generally, the origin position of the array is a geometrical center of the array, and a position of a microphone (for example, the first microphone) in the array may also be used as the origin.

When the number of microphones included in the microphone array is two, in designing of the differential beamforming weighting coefficient, if a 0° direction of an axis Z is used as the shooting direction, that is, a maximum response point, the response is 1. If a 180° direction of the axis Z is used as the opposite direction of the shooting direction, that is, a zero point, the response is 0. In this case, the steering array becomes:

$$D ( ω , θ ) = [ \begin{matrix}{d}^{H} ( ω , 1 ) \\ {d}^{H} ( ω , - 1 )\end{matrix} ] ;$$

and the response matrix β becomes: β=[1 0]. After the first audio and second audio information is collected, the first audio and second audio information is transformed to a frequency domain. If it is assumed that first audio after the transformation to the frequency domain is X₁(ω), and second audio after the transformation to the frequency domain is X₂(ω), X(ω)=[X₁(ω)X₂(ω)]^{T}; after the differential array processing, third audio Y(k) in the frequency domain is obtained, where Y(ω)=h^{T}(ω)X(ω), and third audio in a time domain is obtained after a time-frequency transformation.

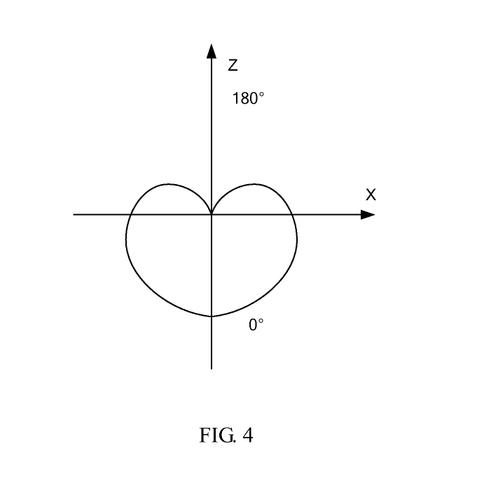

FIG. 4 is a schematic diagram of beam directionality of an overall collecting unit including a first audio collecting unit and a second audio collecting unit after a differential array processing technique is used in Embodiment 2 of an audio information processing method according to the present application.

In FIG. 4, the 0° direction of the axis Z is the shooting direction, and the 180° direction of the axis Z is the opposite direction of the shooting direction. It can be seen that a direction of a maximum value of a cardioid beam is exactly the 0° direction of the axis Z, and a direction of a minimum value is exactly the 180° direction of the axis Z.

The differential array processing technique is a method for adjusting beam directionality of an audio collecting unit in the prior art, and details are not repeatedly described herein.

Step 305: Output the third audio information.

In conclusion, a specific method for processing, when both a first audio collecting unit and a second audio collecting unit are omnidirectional audio collecting units, the first audio information and the second audio information to obtain the third audio information is provided in this embodiment.

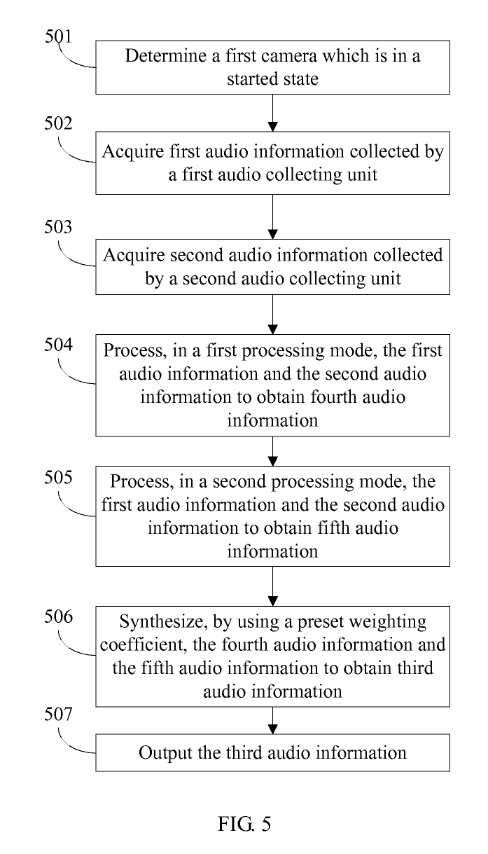

FIG. 5 is a flowchart of Embodiment 3 of an audio information processing method according to the present application. As shown in FIG. 5, the method may include the following steps.

Step 501: Determine the first camera which is in the started state.

Step 502: Acquire first audio information collected by the first audio collecting unit.

Step 503: Acquire second audio information collected by the second audio collecting unit.

Step 504: Process, in a first processing mode, the first audio information and the second audio information to obtain fourth audio information.

Step 505: Process, in a second processing mode, the first audio information and the second audio information to obtain fifth audio information.

In the first processing mode, a beam of an overall collecting unit including the first audio collecting unit and the second audio collecting unit is a first beam. In the second processing mode, a beam of an overall collecting unit including the first audio collecting unit and the second audio collecting unit is a second beam. The first beam and the second beam have different directions.

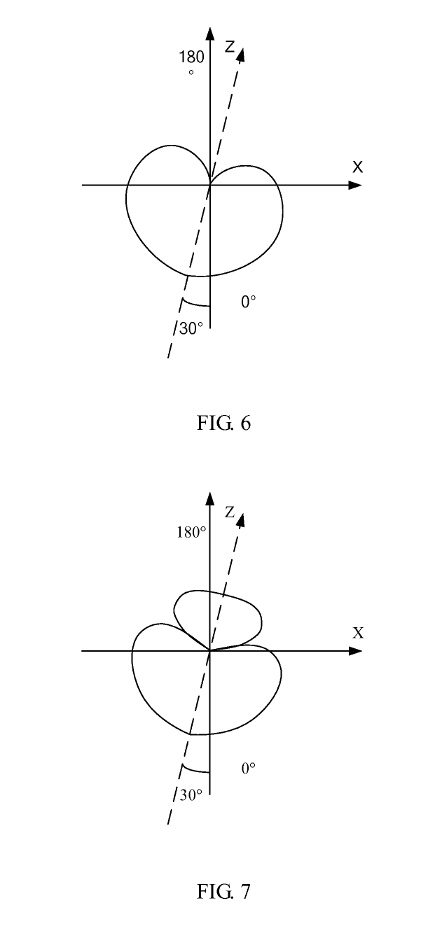

FIG. 6 is a schematic diagram of beam directionality of a first beam of an overall collecting unit including a first audio collecting unit and a second audio collecting unit after a first processing mode is used in Embodiment 3 of an audio information processing method according to the present application.

In this embodiment, a direction of a sound source is still a 0° direction of an axis Z. In FIG. 6, a direction of a beam of the overall collecting unit including the first audio collecting unit and the second audio collecting unit is still a cardioid. However, because of positions in which the first audio collecting unit and the second audio collecting unit are disposed in an electronic device, a direction of a maximum value of the cardioid cannot directly point to the direction of the sound source, but has an included angle with the direction of the sound source. In FIG. 6, the included angle is 30°. In a practical application, a degree of the included angle is not limited to 30°, and may be another degree.

FIG. 7 is a schematic diagram of beam directionality of a second beam of an overall collecting unit including a first audio collecting unit and a second audio collecting unit after a second processing mode is used in Embodiment 3 of an audio information processing method according to the present application.

In FIG. 7, the beam directionality of the second beam is close to a super cardioid. An included angle between a direction of a maximum value of the second beam and the direction of the sound source is also 30° which is the same as the included angle between the direction of the maximum value of the first beam and the direction of the sound source.

Step 506: Synthesize, by using a preset weighting coefficient, the fourth audio information and the fifth audio information to obtain a third audio information.

The third audio information may be synthesized by using the following formula:

$$y ( n ) = {\sum }_{i = 1}^{N} {DMA}_{i} ( n ) W ( i )$$

y(n) denotes synthesized third audio information; DMA,(n) denotes audio information obtained after the i^{th} beam is adopted for processing; W(i) is a preset weighting coefficient of the audio information obtained after the i^{th} beam is processed; N denotes the number of adopted beams; and n denotes a sampling point of an input original audio signal.

In this embodiment, two processing modes are used to process audio information and the number of formed beams is 2, and therefore N=2. The preset weighting coefficient may be set according to an actual situation, and according to the beam directionality in FIG. 6 and FIG. 7, preset weighting coefficients of both the fourth audio information and the fifth audio information may be 0.5 in this embodiment. That is, the fourth audio information and the fifth audio information may be synthesized, by using the following formula, to obtain the third audio information:

y(n)=Σᵢ₌₁²0.5*DMAᵢ(n)

Step 507: Output the third audio information.

It should be noted that in this embodiment, descriptions of the first beam, the second beam, and the preset weighting coefficient are all exemplary. In a practical application, there may be multiple used processing modes beam directionality in each processing mode may also be arbitrary, and the preset weighting coefficient may also be arbitrary as long as a gain of the finally synthesized third audio information in the direction of the sound source is greater than a gain in the opposite direction.

In conclusion, another specific method for processing, when both the first audio collecting unit and the second audio collecting unit are omnidirectional audio collecting units, the first audio information and the second audio information to obtain the third audio information is provided in this embodiment.

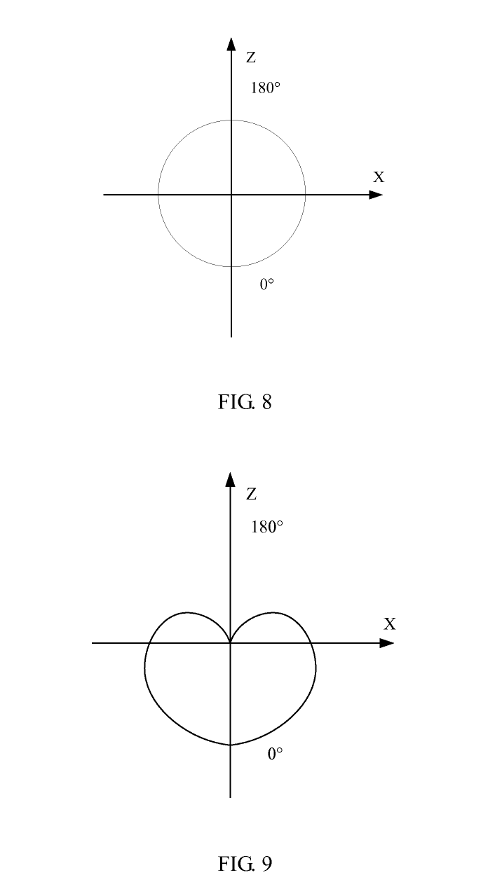

FIG. 8 is a schematic diagram of first beam directionality of a first audio collecting unit in Embodiment 4 of an audio information processing method according to the present application.

FIG. 9 is a schematic diagram of second beam directionality of a first audio collecting unit in Embodiment 4 of an audio information processing method according to the present application.

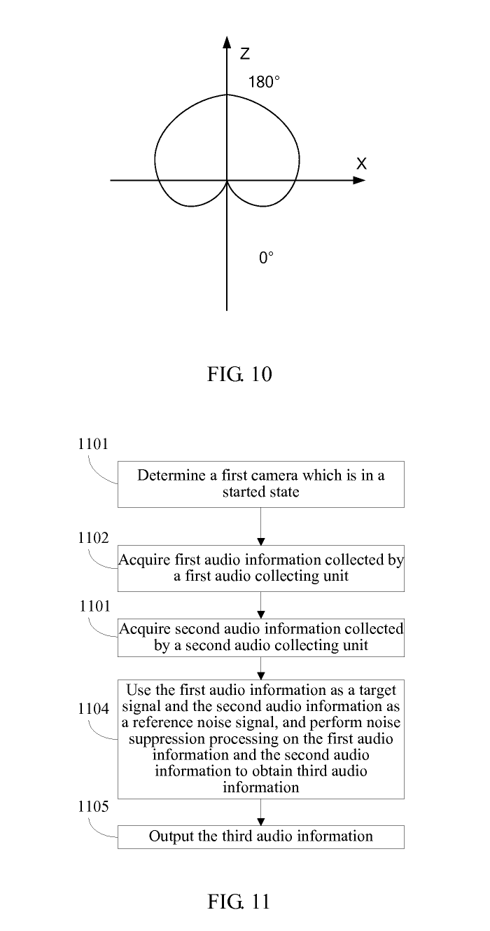

FIG. 10 is a schematic diagram of beam directionality of a second audio collecting unit in Embodiment 4 of an audio information processing method according to the present application.

As shown in FIG. 8 to FIG. 10, the first audio collecting unit is an omnidirectional audio collecting unit or a cardioid audio collecting unit, and the second audio collecting unit is a cardioid audio collecting unit.

In this embodiment, a direction of a maximum value of a cardioid of the first audio collecting unit is the same as a shooting direction and a direction of a minimum value is the same as an opposite direction of the shooting direction. A direction of a maximum value of a cardioid of the second audio collecting unit is the same as the opposite direction of the shooting direction and a direction of a minimum value is the same as the shooting direction.

FIG. 11 is a flowchart of Embodiment 4 of an audio information processing method according to the present application. As shown in FIG. 11, the method may include the following steps.

Step 1101: Determine the first camera which is in the started state.

Step 1102: Acquire first audio information collected by the first audio collecting unit.

Step 1103: Acquire second audio information collected by the second audio collecting unit.

Step 1104: Use the first audio information as a target signal and the second audio information as a reference noise signal and perform noise suppression processing on the first audio information and the second audio information to obtain a third audio information.

The noise suppression processing may be a noise suppression method based on spectral subtraction. After being transformed to a frequency domain, the second audio information that is used as a reference noise signal may be directly used as a noise estimation spectrum in the spectral subtraction. In one embodiment, after being transformed to a frequency domain, the reference noise signal is multiplied by a preset coefficient and then a product is used as a noise estimation spectrum in the spectral subtraction. After being transformed to the frequency domain, the first audio information that is used as a target signal is subtracted by the noise estimation spectrum to obtain a noise-suppressed signal spectrum and then after the noise-suppressed signal spectrum is transformed to a time domain, the third audio information is obtained.

The noise suppression processing may also be a noise suppression method based on an adaptive filtering algorithm. The reference noise signal is used as a noise reference channel in an adaptive filter and noise composition of the target signal is filtered out by using an adaptive filtering method to obtain the third audio information.

The noise suppression processing may further be as follows. After being transformed to the frequency domain, the second audio information that is used as a reference noise signal is used as minimum statistics during a noise spectrum estimation. Noise suppression gain factors on different frequencies are calculated by using a noise suppression method based on statistics. After being transformed to the frequency domain, the first audio information that is used as a target signal is multiplied by the noise suppression gain factors so as to obtain a noise-suppressed frequency spectrum, and then after the noise-suppressed frequency spectrum is transformed to the time domain, the third audio information is obtained.

Step 1105: Output the third audio information.

In this embodiment, the second audio collecting unit itself is a cardioid. In the cardioid, a direction of a maximum value is the same as an opposite direction of a shooting direction. Therefore, for the second audio collecting unit, a gain value of audio information coming from the opposite direction of the shooting direction is the largest. In other words, the second audio collecting unit has a very high sensitivity to noise. Therefore, the first audio information may be used as a target signal and the second audio information as a reference noise signal. The noise suppression processing is performed on the first audio information and the second audio information to obtain the third audio information, so that in synchronously output audio information, volume of a sound source in a final video image is higher than volume of noise outside the video image.

To make volume of audio information corresponding to different video images consistent with areas of the video images, in the foregoing embodiments of the present application, before the outputting the third audio information, the method may further include the following steps.

Determine a first proportion of a video image shot by the first camera in an overall video image and adjust volume of the third audio information according to the first proportion so as to make a proportion of the volume of the third audio information in overall volume the same as the first proportion.

The overall volume is volume when the overall video image is played.

By performing the foregoing steps, volume of an audio signal corresponding to a video image with a smaller image size can be made lower and volume of an audio signal corresponding to a video image with a larger image size can be made higher.

The present application further provides another audio information processing method. The method is applied to an electronic device where the electronic device has at least a front-facing camera and a rear-facing camera. A camera in a started state from the front-facing camera and the rear-facing camera is a first camera. There is at least one first audio collecting unit on one side on which the first camera is located and there is at least one second audio collecting unit on the other side. A beam of the first audio collecting unit is a cardioid, a direction of a maximum value of the cardioid is the same as a shooting direction, and a direction of a minimum value is the same as an opposite direction of the shooting direction.

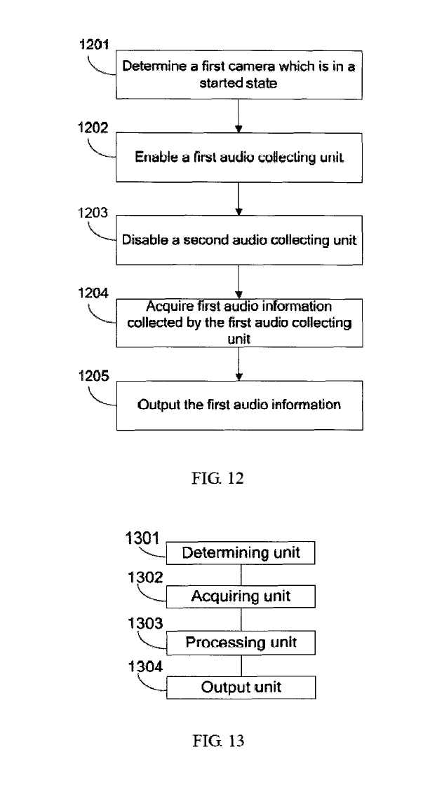

FIG. 12 is a flowchart of Embodiment 1 of another audio information processing method according to the present application. As shown in FIG. 12, the method may include the following steps.

Step 1201: Determine the first camera which is in the started state.

Step 1202: Enable the first audio collecting unit.

Step 1203: Disable the second audio collecting unit.

Step 1204: Acquire first audio information collected by the first audio collecting unit.

Step 1205: Output the first audio information.

In this embodiment, because a direction of a maximum value of a beam of the first audio collecting unit is the same as the shooting direction for audio information directly acquired by the first audio collecting unit itself, a gain of audio information coming from the shooting direction is greater than a gain of audio information coming from the opposite direction of the shooting direction. Therefore, the first audio collecting unit may be directly used to collect audio information and the second audio collecting unit is disabled so that the second audio collecting unit can be prevented from collecting noise from the opposite direction. Ultimately, in synchronously output audio information, volume of a target sound source in a formed video image can also be made higher than volume of noise or an interfering sound source outside the video image.

The present application further provides an audio information processing apparatus. The apparatus is applied to an electronic device. The electronic device has at least a front-facing camera and a rear-facing camera. A camera in a started state from the front-facing camera and the rear-facing camera is a first camera. There is at least one first audio collecting unit on one side on which the first camera is located and there is at least one second audio collecting unit on the other side.

The electronic device may be an electronic device such as a mobile phone, a tablet computer, a digital camera, or a digital video recorder. The camera may be the front-facing camera and may also be the rear-facing camera. The audio collecting unit may be a microphone. The electronic device of the present application has at least two audio collecting units. The first audio collecting unit and the second audio collecting unit are separately located on two sides of the electronic device. When the first camera is the front-facing camera, the first audio collecting unit is on a side on which the front-facing camera of the electronic device is located and the second audio collecting unit is on a side on which the rear-facing camera of the electronic device is located. When the first camera is the rear-facing camera, the first audio collecting unit is on the side on which the rear-facing camera of the electronic device is located and the second audio collecting unit is on the side on which the front-facing camera of the electronic device is located.

FIG. 13 is a flowchart of Embodiment 1 of an audio information processing apparatus according to the present application. As shown in FIG. 13, the apparatus may include a determining unit 1301, an acquiring unit 1302, a processing unit 1303, and an output unit 1304.

The determining unit 1301 is configured to determine the first camera which is in the started state.

Generally, the camera of the electronic device is not in the started state all the time. When it is required to use the camera to shoot an image, the camera of the electronic device may be started.

When the camera is started, it may be determined, according to a signal change of a circuit of the camera, whether the camera in the started state is the front-facing camera or the rear-facing camera. The front-facing camera and the rear-facing camera may also be in the started state at the same time.

It should be noted that a button used to indicate a state of the camera may also be specifically configured for the electronic device. After a user performs an operation on the button, it can be determined that the camera is in the started state. It should further be noted that on some special occasions, after performing an operation on the button, the user may only switch the state of the camera and does not necessarily really start the camera at a physical level.

It should further be noted that when the electronic device has multiple cameras, the unit can determine that a camera in the started state is the first camera.

For example, the electronic device has a front-facing camera and a rear-facing camera. If the front-facing camera is in the started state, the unit can determine that the front-facing camera is the first camera, the first audio collecting unit is on a side on which the front-facing camera of the electronic device is located, and the second audio collecting unit is on a side on which the rear-facing camera of the electronic device is located. If the rear-facing camera is in the started state, the unit can determine that the front-facing camera is the first camera, the first audio collecting unit is on the side on which the rear-facing camera of the electronic device is located, and the second audio collecting unit is on the side on which the front-facing camera of the electronic device is located.

If both the front-facing camera and the rear-facing camera are in the started state, for audio information collected in real time by all audio collecting units of the electronic device, the audio information processing method of the present application may be performed by using the front-facing camera as the first camera so as to obtain one piece of third audio information with the front-facing camera used as the first camera. Meanwhile, the audio information processing method of the present application is performed by using the rear-facing camera as the first camera so as to obtain one piece of third audio information with the rear-facing camera used as the first camera. tThese two pieces of third audio information are output at the same time. When the front-facing camera is used as the first camera, the first audio collecting unit is on the side on which the front-facing camera of the electronic device is located and the second audio collecting unit is on the side on which the rear-facing camera of the electronic device is located. When the rear-facing camera is used as the first camera, the first audio collecting unit is on the side on which the rear-facing camera of the electronic device is located and the second audio collecting unit is on the side on which the front-facing camera of the electronic device is located.

The acquiring unit 1302 is configured to acquire first audio information collected by the first audio collecting unit, and further configured to acquire second audio information collected by the second audio collecting unit.

When the first audio collecting unit is powered on and works properly, audio information that can be collected by the first audio collecting unit is the first audio information.

When the second audio collecting unit is powered on and works properly, audio information that can be collected by the second audio collecting unit is the second audio information.

The processing unit 1303 is configured to process the first audio information and the second audio information to obtain third audio information. For the third audio information, a gain of a sound signal coming from a shooting direction of the first camera is a first gain. For the third audio information, a gain of a sound signal coming from an opposite direction of the shooting direction is a second gain. The first gain is greater than the second gain.

By using a sound processing technique, different adjustments may be made to audio information from different directions so that adjusted audio information has different gains in different directions. After being processed, audio information collected from a direction in which there is a larger gain has higher volume. After being processed, audio information collected from a direction in which there is a smaller gain has lower volume.

When the camera is the front-facing camera, the shooting direction of the camera is a direction which the front of the electronic device faces. When the camera is the rear-facing camera, the shooting direction of the camera is a direction which the rear of the electronic device faces.

When the camera is used for shooting, audio information, such as a person's voice, that the electronic device needs to collect generally comes from a shooting range. Therefore, the gain of the sound signal coming from the shooting direction of the camera is adjusted to be the first gain with a larger gain value, which can increase volume of the audio information from the shooting range, making volume of a target speaker's voice expected to be recorded higher. In addition, the gain of the sound signal coming from the opposite direction of the shooting direction is adjusted to be the second gain with a smaller gain value, which can suppress volume of audio information from a non-shooting range, making volume of noise or an interfering sound source in a background lower.

The output unit 1304 is configured to output the third audio information.

The outputting the third audio information may be that the third audio information is output to a video file for storing, where the video file is recorded by the electronic device, and may also be that the third audio information is directly output and transmitted to an electronic device which is communicating with the electronic device for direct real-time play.

In conclusion, according to the apparatus of this embodiment, a first camera is determined, audio information collected by the first audio collecting unit and the second audio collecting unit is processed to obtain third audio information, where for the third audio information, a gain of a sound signal from a shooting direction of the camera is a first gain with a larger gain value and a gain of a sound signal from an opposite direction of the shooting direction is a second gain with a smaller gain value so that when an electronic device is used for video shooting and audio collecting at the same time, volume of a target sound source in a video shooting direction can be increased and volume of noise and an interfering sound source in an opposite direction of the video shooting direction can be decreased. Therefore, in synchronously output audio information, volume of a sound source in a final video image is higher than volume of noise or an interfering sound source outside the video image.

In a practical application, when both the first audio collecting unit and the second audio collecting unit are omnidirectional audio collecting units, the processing unit 1303 may be specifically configured to process, by using a differential array processing technique, the first audio information and the second audio information to obtain the third audio information.

After the differential array processing technique is used, a beam of an overall collecting unit including the first audio collecting unit and the second audio collecting unit is a cardioid, a direction of a maximum value of the cardioid is the same as the shooting direction, and a direction of a minimum value is the same as an opposite direction of the shooting direction.

In a practical application, when both the first audio collecting unit and the second audio collecting unit are omnidirectional audio collecting units, the processing unit 1303 may be further configured to process, in a first processing mode, the first audio information and the second audio information to obtain fourth audio information and process, in a second processing mode, the first audio information and the second audio information to obtain fifth audio information. In the first processing mode, a beam of an overall collecting unit including the first audio collecting unit and the second audio collecting unit is a first beam. In the second processing mode, a beam of an overall collecting unit including the first audio collecting unit and the second audio collecting unit is a second beam. The first beam and the second beam have different directions. The processing unit 1303 may also synthesize, by using a preset weighting coefficient, the fourth audio information and the fifth audio information to obtain the third audio information.

In a practical application, when the first audio collecting unit is an omnidirectional audio collecting unit and the second audio collecting unit is a cardioid audio collecting unit, where a direction of a maximum value of the cardioid is the same as the opposite direction of the shooting direction and a direction of a minimum value is the same as the shooting direction, the processing unit 1303 may be configured to use the first audio information as a target signal and the second audio information as a reference noise signal and perform noise suppression processing on the first audio information and the second audio information to obtain the third audio information.

In a practical application, when the first audio collecting unit is a first cardioid audio collecting unit and the second audio collecting unit is a second cardioid audio collecting unit, where a direction of a maximum value of the first cardioid is the same as the shooting direction, a direction of a minimum value is the same as the opposite direction of the shooting direction, a direction of a maximum value of the second cardioid is the same as the opposite direction of the shooting direction, and a direction of a minimum value is the same as the shooting direction, the processing unit 1303 may be configured to use the first audio information as a target signal and the second audio information as a reference noise signal and perform noise suppression processing on the first audio information and the second audio information to obtain the third audio information.

In a practical application, the determining unit 1301 may be further configured to, before the third audio information is output, determine a first proportion of a video image shot by the first camera in an overall video image.

The processing unit 1303 is further configured to adjust volume of the third audio information according to the first proportion so as to make a proportion of the volume of the third audio information in overall volume the same as the first proportion.

The overall volume is volume when the overall video image is played.

The present application further provides another audio information processing apparatus. The apparatus is applied to an electronic device, where the electronic device has at least a front-facing camera and a rear-facing camera. A camera in a started state from the front-facing camera and the rear-facing camera is a first camera. There is at least one first audio collecting unit on one side on which the first camera is located and there is at least one second audio collecting unit on the other side. A beam of the first audio collecting unit is a cardioid. A direction of a maximum value of the cardioid is the same as a shooting direction and a direction of a minimum value is the same as an opposite direction of the shooting direction.

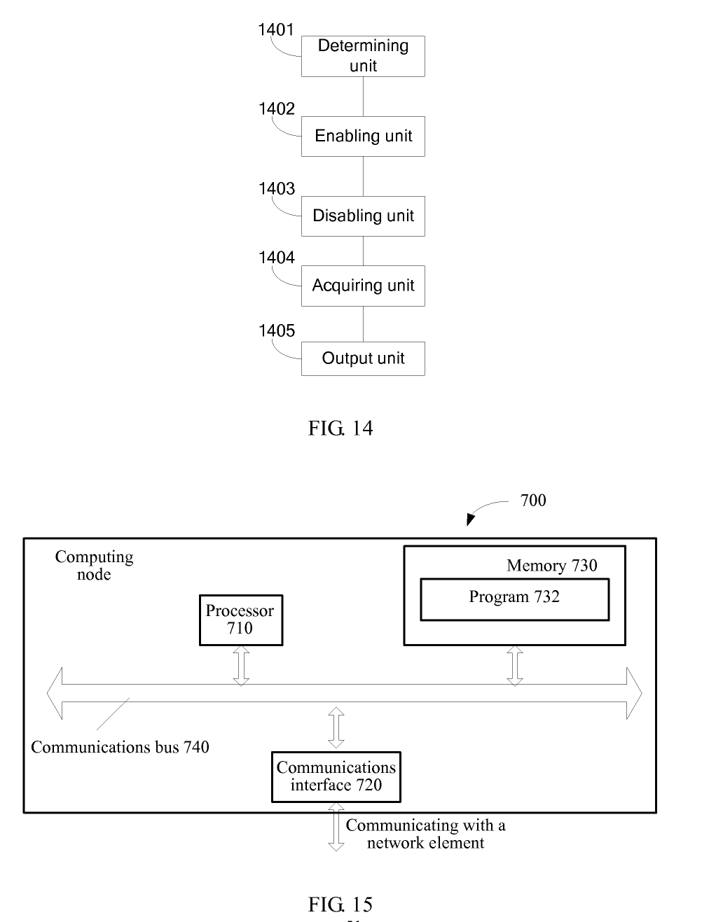

FIG. 14 is a structural diagram of Embodiment 1 of another audio information processing apparatus according to the present application. As shown in FIG. 14, the apparatus may include a determining unit 1401 configured to determine the first camera which is in the started state, an enabling unit 1402 configured to enable the first audio collecting unit, a disabling unit 1403 configured to disable the second audio collecting unit, an acquiring unit 1404 configured to acquire first audio information collected by the first audio collecting unit, and an output unit 1405 configured to output the first audio information.

In this embodiment, because a direction of a maximum value of a beam of the first audio collecting unit is the same as the shooting direction, for audio information directly acquired by the first audio collecting unit itself, a gain of audio information coming from the shooting direction is greater than a gain of audio information coming from the opposite direction of the shooting direction. Therefore, the first audio collecting unit may be directly used to collect audio information and the second audio collecting unit is disabled so that the second audio collecting unit can be prevented from collecting noise from the opposite direction. Ultimately, in synchronously output audio information, volume of a target sound source in a formed video image can be made higher than volume of noise or an interfering sound source outside the video image.

In addition, an embodiment of the present application further provides a computing node, where the computing node may be a host server that has a computing capability, a personal computer (PC), a portable computer or terminal, or the like. A specific embodiment of the present application imposes no limitation on specific implementation of the computing node.

FIG. 15 is a structural diagram of a computing node according to the present application. As shown in FIG. 15, the computing node 700 includes a processor 710, a communications interface 720, a memory 730, and a bus 740.

The processor 710, the communications interface 720, and the memory 730 complete mutual communication by using the bus 740.

The processor 710 is configured to execute a program 732.

The program 732 may include program code where the program code includes a computer operation instruction.

The processor 710 may be a central processing unit (CPU) or an application-specific integrated circuit (ASIC), or one or more integrated circuits configured to implement this embodiment of the present application.

The memory 730 is configured to store the program 732. The memory 730 may include a high-speed random access memory (RAM) memory and may also include a non-volatile memory, for example, at least one disk memory.

For specific implementation of modules in the program 732, refer to corresponding modules or units in the embodiments shown in FIG. 12 and FIG. 13. Details are not repeatedly described herein.

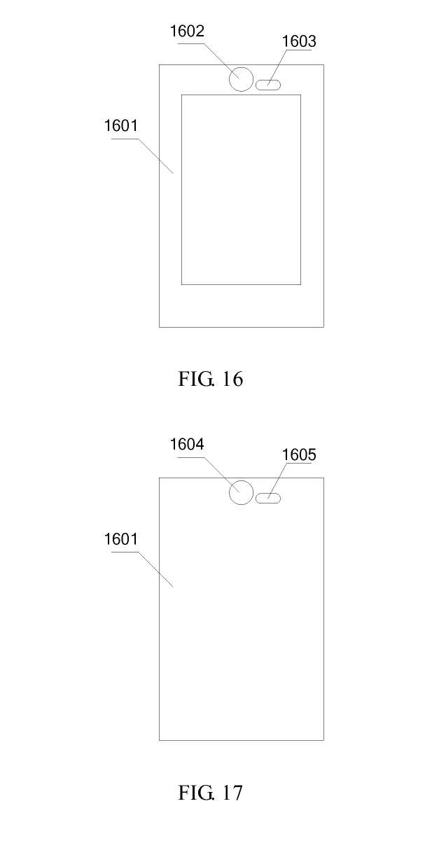

The present application further provides an electronic device. The electronic device may be a terminal such as a mobile phone. FIG. 16 is a front schematic structural diagram of an electronic device embodiment according to the present application. FIG. 17 is a rear schematic structural diagram of an electronic device embodiment according to the present application. As shown in FIG. 16 and FIG. 17, the electronic device 1601 has at least a front-facing camera 1602 and a rear-facing camera 1604. A camera in a started state from the front-facing camera 1602 and the rear-facing camera 1604 is a first camera. There is at least one audio collecting unit 1603 on a side on which the front-facing camera 1602 is located and there is at least one audio collecting unit 1605 on a side on which the rear-facing camera 1604 is located. When the front-facing camera 1602 is the first camera, the audio collecting unit 1603 on the side on which the front-facing camera 1602 is located is configured as a first audio collecting unit and the audio collecting unit 1605 on the side on which the rear-facing camera 1604 is located is configured as a second audio collecting unit. When the rear-facing camera 1604 is the first camera, the audio collecting unit 1605 on the side on which the rear-facing camera 1604 is located is configured as a first audio collecting unit and the audio collecting unit 1603 on the side on which the front-facing camera 1602 is located is configured as a second audio collecting unit. The electronic device further includes the audio information processing apparatus shown in FIG. 13 (not shown in FIG. 16 and FIG. 17).

In conclusion, according to the electronic device of the present application, a first camera is determined. Audio information collected by the first audio collecting unit and the second audio collecting unit is processed to obtain third audio information. For the third audio information, a gain of a sound signal coming from a shooting direction of the camera is a first gain with a larger gain value and a gain of a sound signal coming from an opposite direction of the shooting direction is a second gain with a smaller gain value so that when the electronic device is used for video shooting and audio collecting at the same time, volume of a target sound source in a video shooting direction can be increased and volume of noise or an interfering sound source in an opposite direction of the video shooting direction can be decreased. Therefore, in synchronously output audio information, volume of a sound source in a final video image is higher than volume of noise or an interfering sound source outside the video image.

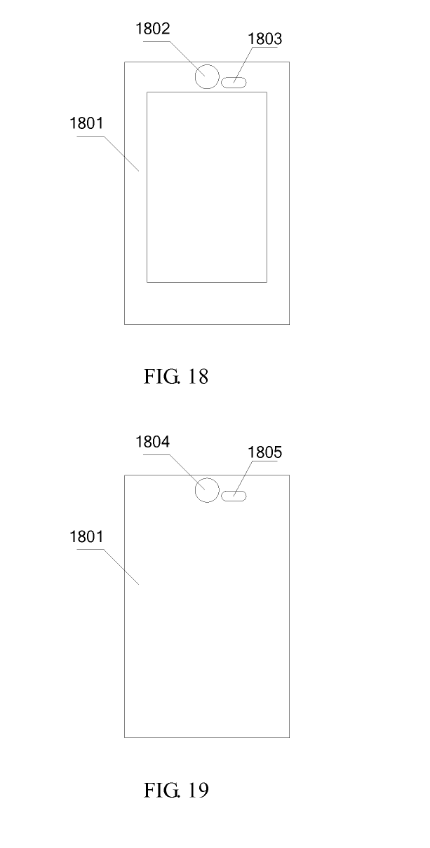

The present application further provides another electronic device. The electronic device may be a terminal such as a mobile phone. FIG. 18 is a front schematic structural diagram of an electronic device embodiment according to the present application. FIG. 19 is a rear schematic structural diagram of an electronic device embodiment according to the present application. As shown in FIG. 18 and FIG. 19, the electronic device 1801 has at least a front-facing camera 1802 and a rear-facing camera 1804. A camera in a started state from the front-facing camera 1802 and the rear-facing camera 1804 is a first camera. There is at least one audio collecting unit 1803 on a side on which the front-facing camera 1802 is located and there is at least one audio collecting unit 1805 on a side on which the rear-facing camera 1804 is located. When the front-facing camera 1802 is the first camera, the audio collecting unit 1803 on the side on which the front-facing camera 1802 is located is configured as a first audio collecting unit and the audio collecting unit 1805 on the side on which the rear-facing camera 1804 is located is configured as a second audio collecting unit. When the rear-facing camera 1804 is the first camera, the audio collecting unit 1805 on the side on which the rear-facing camera 1804 is located is configured as a first audio collecting unit and the audio collecting unit 1803 on the side on which the front-facing camera 1802 is located is configured as a second audio collecting unit. The electronic device further includes the audio information processing apparatus shown in FIG. 14 (not shown in FIG. 18 and FIG. 19).

A beam of the first audio collecting unit is a cardioid, where a direction of a maximum value of the cardioid is the same as a shooting direction and a direction of a minimum value is the same as an opposite direction of the shooting direction.

In this embodiment, because a direction of a maximum value of a beam of the first audio collecting unit is the same as the shooting direction, for audio information directly acquired by the first audio collecting unit itself, a gain of audio information coming from the shooting direction is greater than a gain of audio information coming from the opposite direction of the shooting direction. Therefore, the first audio collecting unit may be directly used to collect audio information and the second audio collecting unit is disabled so that the second audio collecting unit is prevented from collecting noise from the opposite direction. Ultimately, in synchronously output audio information, volume of a target sound source in a formed video image can also be made higher than volume of noise or an interfering sound source outside the video image.

Finally, it should further be noted that in this specification, relational terms such as first and second are only used to distinguish one entity or operation from another, and do not necessarily require or imply that any actual relationship or sequence exists between these entities or operations. Moreover, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the existence of additional identical elements in the process, method, article, or apparatus that includes the element.

Based on the foregoing descriptions of the embodiments, a person skilled in the art may clearly understand that the present application may be implemented by software in addition to a necessary hardware platform or by hardware only. In most circumstances, the former is a preferred implementation manner. Based on such an understanding, all or a part of the technical solutions of the present application contributing to the technology in the background part may be implemented in the form of a software product. The computer software product may be stored in a storage medium, such as a read-only memory (ROM)/RAM, a magnetic disk, or an optical disc, and includes several instructions for instructing a computer device (which may be a personal computer, a server, a network device, or the like) to perform the methods described in the embodiments or some parts of the embodiments of the present application.

The embodiments in this specification are all described in a progressive manner, for same or similar parts in the embodiments, reference may be made to these embodiments, and each embodiment focuses on a difference from other embodiments. The apparatus disclosed in the embodiments is described relatively simply because it corresponds to the method disclosed in the embodiments, and for portions related to those of the method, reference may be made to the description of the method.

Specific examples are used in this specification to describe the principle and implementation manners of the present application. The foregoing embodiments are merely intended to help understand the method and core idea of the present application. In addition, with respect to the implementation manners and the application scope, modifications may be made by a person of ordinary skill in the art according to the idea of the present application. Therefore, the content of this specification shall not be construed as a limitation to the present application.

What is claimed is:

1. An audio information processing method applied to an electronic device having at least one front-facing camera and one rear-facing camera, wherein a camera in a started state from the front-facing camera and the rear-facing camera is a first camera; at least one audio collecting unit on a side on which the front-facing camera is located, and at least one audio collecting unit on a side on which the rear-facing camera is located, wherein when the front-facing camera is the first camera, the audio collecting unit on the side on which the front-facing camera is located is configured as a first audio collecting unit and the audio collecting unit on the side on which the rear-facing camera is located is configured as a second audio collecting unit, wherein when the rear-facing camera is the first camera, the audio collecting unit on the side on which the rear-facing camera is located is configured as a first audio collecting unit and the audio collecting unit on the side on which the front-facing camera is located is configured as a second audio collecting unit, and the method comprises:
determining the first camera;
acquiring first audio information collected by the first audio collecting unit;
acquiring second audio information collected by the second audio collecting unit;
processing the first audio information and the second audio information to obtain third audio information, wherein a gain of a sound signal coming from a shooting direction of the first camera is a first gain for the third audio information, a gain of a sound signal coming from an opposite direction of the shooting direction is a second gain for the third audio information, and the first gain is greater than the second gain; and
outputting the third audio information.

2. The method according to claim 1, wherein both the first audio collecting unit and the second audio collecting unit are omnidirectional audio collecting units, and wherein the processing the first audio information and the second audio information to obtain third audio information specifically comprises:
processing, by using a differential array processing technique, the first audio information and the second audio information to obtain the third audio information,
wherein after the processing by using the differential array processing technique is performed, a beam of an overall collecting unit comprising the first audio collecting unit and the second audio collecting unit is a cardioid, and
wherein a direction of a maximum value of the cardioid is the same as the shooting direction, and a direction of a minimum value is the same as the opposite direction of the shooting direction.

3. The method according to claim 1, wherein both the first audio collecting unit and the second audio collecting unit are omnidirectional audio collecting units, and wherein the processing the first audio information and the second audio information to obtain third audio information comprises:
processing, in a first processing mode, the first audio information and the second audio information to obtain fourth audio information;
processing, in a second processing mode, the first audio information and the second audio information to obtain fifth audio information,
wherein, in the first processing mode, a beam of an overall collecting unit comprising the first audio collecting unit and the second audio collecting unit is a first beam, and wherein, in the second processing mode, a beam of an overall collecting unit comprising the first audio collecting unit and the second audio collecting unit is a second beam, wherein the first beam and the second beam have different directions; and
synthesizing, according to a preset weighting coefficient, the fourth audio information and the fifth audio information to obtain the third audio information.

4. The method according to claim 1, wherein the first audio collecting unit is an omnidirectional audio collecting unit, wherein the second audio collecting unit is a cardioid audio collecting unit, wherein a direction of a maximum value of the cardioid is the same as the opposite direction of the shooting direction, wherein a direction of a minimum value is the same as the shooting direction and wherein the processing the first audio information and the second audio information to obtain third audio information comprises:
using the first audio information as a target signal and the second audio information as a reference noise signal, and
performing noise suppression processing on the first audio information and the second audio information to obtain the third audio information.

5. The method according to claim 1, wherein the first audio collecting unit is a first cardioid audio collecting unit, wherein the second audio collecting unit is a second cardioid audio collecting unit, wherein a direction of a maximum value of the first cardioid is the same as the shooting direction, wherein a direction of a minimum value is the same as the opposite direction of the shooting direction, wherein a direction of a maximum value of the second cardioid is the same as the opposite direction of the shooting direction, wherein a direction of a minimum value is the same as the shooting direction, and wherein the processing the first audio information and the second audio information to obtain third audio information specifically comprises:
using the first audio information as a target signal and the second audio information as a reference noise signal, and
performing noise suppression processing on the first audio information and the second audio information to obtain the third audio information.

6. An audio information processing method applied to an electronic devicehaving at least a front-facing camera and a rear-facing camera, wherein a camera in a started state from the front-facing camera and the rear-facing camera is a first camera, at least one audio collecting unit on a side on which the front-facing camera is located, and at least one audio collecting unit on a side on which the rear-facing camera is located, wherein when the front-facing camera is the first camera, the audio collecting unit on the side on which the front-facing camera is located is configured as a first audio collecting unit and the audio collecting unit on the side on which the rear-facing camera is located is configured as a second audio collecting unit, wherein when the rear-facing camera is the first camera, the audio collecting unit on the side on which the rear-facing camera is located is configured as a first audio collecting unit and the audio collecting unit on the side on which the front-facing camera is located is configured as a second audio collecting unit, and the method comprises:
determining the first camera;
enabling the first audio collecting unit;
disabling the second audio collecting unit;
acquiring first audio information collected by the first audio collecting unit; and
outputting the first audio information.

7. An audio information processing apparatus applied to an electronic device having at least a front-facing camera and a rear-facing camera, wherein a camera in a started stateₛ from the front-facing camera and the rear-facing camera is a first camera, at least one audio collecting unit on a side on which the front-facing camera is located, and at least one audio collecting unit on a side on which the rear-facing camera is located, wherein when the front-facing camera is the first camera, the audio collecting unit on the side on which the front-facing camera is located is configured as a first audio collecting unit and the audio collecting unit on the side on which the rear-facing camera is located is configured as a second audio collecting unit, wherein when the rear-facing camera is the first camera, the audio collecting unit on the side on which the rear-facing camera is located is configured as a first audio collecting unit and the audio collecting unit on the side on which the front-facing camera is located is configured as a second audio collecting units and the apparatus comprises:
a determining unit configured to determine the first camera;
an acquiring unit configured to acquire first audio information collected by the first audio collecting unit and to acquire second audio information collected by the second audio collecting unit;
a processing unit configured to process the first audio information and the second audio information to obtain third audio information, wherein a gain of a sound signal coming from a shooting direction of the first camera is a first gain for the third audio information, a gain of a sound signal coming from an opposite direction of the shooting direction is a second gain for the third audio information, and the first gain is greater than the second gain; and
an output unit configured to output the third audio information.

8. The apparatus according to claim 7, wherein both the first audio collecting unit and the second audio collecting unit are omnidirectional audio collecting units, and wherein the processing unit is configured to:
process, by using a differential array processing technique, the first audio information and the second audio information to obtain the third audio information,
wherein after the processing by using the differential array processing technique is performed, a beam of an overall collecting unit comprising the first audio collecting unit and the second audio collecting unit is a cardioid, and
wherein a direction of a maximum value of the cardioid is the same as the shooting direction, and a direction of a minimum value is the same as the opposite direction of the shooting direction.

9. The apparatus according to claim 7, wherein both the first audio collecting unit and the second audio collecting unit are omnidirectional audio collecting units, and wherein the processing unit is configured to:
process, in a first processing mode, the first audio information and the second audio information to obtain fourth audio information;
process, in a second processing mode, the first audio information and the second audio information to obtain fifth audio information,
wherein, in the first processing mode, a beam of an overall collecting unit comprising the first audio collecting unit and the second audio collecting unit is a first beam, and
wherein, in the second processing mode, a beam of an overall collecting unit comprising the first audio collecting unit and the second audio collecting unit is a second beam, wherein the first beam and the second beam have different directions; and
synthesize, according to a preset weighting coefficient, the fourth audio information and the fifth audio information to obtain the third audio information.

10. The apparatus according to claim 7, wherein the first audio collecting unit is an omnidirectional audio collecting unit, wherein the second audio collecting unit is a cardioid audio collecting unit, wherein a direction of a maximum value of the cardioid is the same as the opposite direction of the shooting direction, wherein a direction of a minimum value is the same as the shooting direction, and wherein the processing unit is configured to:
use the first audio information as a target signal and the second audio information as a reference noise signal; and
perform noise suppression processing on the first audio information and the second audio information to obtain the third audio information.

11. The apparatus according to claim 7, wherein the first audio collecting unit is a first cardioid audio collecting unit, wherein the second audio collecting unit is a second cardioid audio collecting unit, wherein a direction of a maximum value of the first cardioid is the same as the shooting direction, wherein a direction of a minimum value is the same as the opposite direction of the shooting direction, wherein a direction of a maximum value of the second cardioid is the same as the opposite direction of the shooting direction, wherein a direction of a minimum value is the same as the shooting direction, and wherein the processing unit is configured to:
use the first audio information as a target signal and the second audio information as a reference noise signal; and
perform noise suppression processing on the first audio information and the second audio information to obtain the third audio information.

12. An audio information processing apparatus applied to an electronic device having at least a front-facing camera and a rear-facing camera, wherein a camera in a started state from the front-facing camera and the rear-facing camera is a first camera, at least one audio collecting unit on a side on which the front-facing camera is located, and at least one audio collecting unit on a side on which the rear-facing camera is located, wherein when the front-facing camera is the first camera, the audio collecting unit on the side on which the front-facing camera is located is configured as a first audio collecting unit and the audio collecting unit on the side on which the rear-facing camera is located is configured as a second audio collecting unit, wherein when the rear-facing camera is the first camera, the audio collecting unit on the side on which the rear-facing camera is located is configured as a first audio collecting unit and the audio collecting unit on the side on which the front-facing camera is located is configured as a second audio collecting unit, wherein a beam of the first audio collecting unit is a cardioid, wherein a direction of a maximum value of the cardioid is the same as a shooting direction, wherein a direction of a minimum value is the same as an opposite direction of the shooting direction, and wherein the apparatus comprises:
a determining unit configured to determine the first camera;
an enabling unit configured to enable the first audio collecting unit;
a disabling unit configured to disable the second audio collecting unit;
an acquiring unit configured to acquire first audio information collected by the first audio collecting unit; and
an output unit configured to output the first audio information.

13. An electronic devicehaving at least a front-facing camera and a rear-facing camera, wherein a camera in a started stateₛ from the front-facing camera and the rear-facing camera is a first camera, at least one audio collecting unit on a side on which the front-facing camera is located, and at least one audio collecting unit on a side on which the rear-facing camera is located, wherein when the front-facing camera is the first camera, the audio collecting unit on the side on which the front-facing camera is located is configured as a first audio collecting unit and the audio collecting unit on the side on which the rear-facing camera is located is configured as a second audio collecting unit, wherein when the rear-facing camera is the first camera, the audio collecting unit on the side on which the rear-facing camera is located is configured as a first audio collecting unit and the audio collecting unit on the side on which the front-facing camera is located is configured as a second audio collecting unit, and wherein the electronic device further comprises the audio information processing apparatus according to claim 7.

14. An electronic device having at least a front-facing camera and a rear-facing cameras, wherein a camera in a started state from the front-facing camera and the rear-facing camera is a first camera, at least one audio collecting unit on a side on which the front-facing camera is located, and at least one audio collecting unit on a side on which the rear-facing camera is located, when the front-facing camera is the first camera, the audio collecting unit on the side on which the front-facing camera is located is configured as a first audio collecting unit and the audio collecting unit on the side on which the rear-facing camera is located is configured as a second audio collecting unit, wherein when the rear-facing camera is the first camera, the audio collecting unit on the side on which the rear-facing camera is located is configured as a first audio collecting unit and the audio collecting unit on the side on which the front-facing camera is located is configured as a second audio collecting unit, wherein a beam of the first audio collecting unit is a cardioid, wherein a direction of a maximum value of the cardioid is the same as a shooting direction, wherein a direction of a minimum value is the same as an opposite direction of the shooting direction, and wherein the electronic device further comprises the audio information processing apparatus according to claim 12.
